(19) United States
(12) Patent Application Publication
(10) Pub. No.: US 2003/0082341 A1
(43) Pub. Date: May 1, 2003

(54) FRP plate member fabrication method and its finished products

(76) Inventor: Chin Fa Chu, Kaohsiung (TW)

Correspondence Address: BRUCE H. TROXELL, SUITE 1404, 5205 LEESBURG PIKE, FALLS CHURCH, VA, 22041, US

(21) Appl. No.: 10/040,486

(22) Filed: Jan. 9, 2002

(30) Foreign Application Priority Data
Nov. 1, 2001 (TW) 090100638

(51) Int. Cl. B32B 3/10; B29C 70/30

(52) U.S. Cl. 428/138; 264/338; 264/257; 264/544; 264/297.1

(57) ABSTRACT

A FRP plate member fabrication method includes the steps of: (a) form preparation to prepare a form having a cavity made subject to predetermined dimensions and pattern, (b) coating and hardening to coat the cavity with a layer of mold releasing agent and a layer of face material on the layer of mold releasing agent and then to harden the layer of face material, (c) FRP layer formation to coat a layer of FRP on the layer of face material and then to harden the coating, (d) resin coating to coat a layer of resin on the layer of FRP, (e) sheet member adding to bond a backing sheet to the layer of resin, (f) pressure application and mass production to compress backing sheet against the form and then to repeat the steps from (a) through (e) for making multiple FRP plate members at a time, and (g) form releasing to release the molded and hardened FRP plate members from the form.

### BACKGROUND OF THE INVENTION

1. Field of The Invention

The present invention relates to a FRP plate member fabrication method, which greatly reduces FRP plate member manufacturing cost and, widens FRP plate member application arrange.

2. Description of Related Art

Plastics, wooden material, and FRP (fiberglass reinforced plastics are commonly used for making door panels. Wooden door panels are heavy and expensive, and weak against acid, alkali, and fire. On the contrary, FRP door panels are light and inexpensive, and strong against acid, alkali, and fire. A regular wooden door panel is comprised of a frame base and two face boards fastened to the frame base at two sides. However, FRP material is fragile. A thin sheet of FRP material breaks easily when bent. A plate member of FRP material should be made having a certain thickness. FIG. 1 is a FRP plate member fabrication flow chart according to the prior art. This FRP plate member fabrication method includes the steps of form preparation 11, spray-coating 12, hardening 13, surface material application 14, and form releasing 15. The step of form preparation 11 is to prepare a form having a cavity constructed subject to predetermined dimensions and pattern. The step of spray-coating 12 is to spray-coat the cavity of the form with a layer of mold releasing agent and a layer of liquid FRP (fiberglass reinforced plastics) on the layer of mold releasing agent. The step of hardening 13 is to harden the layer of FRP coasting. The step of surface material application 14 is to coat the layer of FRP with a layer of face material subject to the desired color. The step of form releasing 15 is to release the finished FRP plate member from the mold. This FRP plate member fabrication method is less efficient because it is not suitable for mass production. Another drawback of this FRP plate member fabrication method is its high manufacturing cost.

### SUMMARY OF THE INVENTION

The present invention has been accomplished to provide a FRP plate member fabrication method, which eliminates the aforesaid drawbacks.

It is one object of the present invention to provide a FRP plate member fabrication method, which is suitable for mass production.

It is another object of the present invention to provide a FRP plate member fabrication method, which greatly improves the quality of FRP plate members.

It is still another object of the present invention to provide a FRP plate member fabrication method, which greatly widens the application range of FRP plate members.

According to the present invention, the FRP plate member fabrication method includes the steps of: (a) form preparation to prepare a form having a cavity made subject to predetermined dimensions and pattern, (b) coating and hardening to coat the cavity with a layer of mold releasing agent and a layer of face material on the layer of mold releasing agent and then to harden the layer of face material, (c) FRP layer formation to coat a layer of FRP on the layer of face material and then to harden the coating, (d) resin coating to coat a layer of resin on the layer of FRP, (e) sheet member adding to bond a backing sheet to the layer of resin, (f) pressure application and mass production to compress backing sheet against the form and then to repeat the steps from (a) through (e) for making multiple FRP plate members at a time, and (g) form releasing to release the molded and hardened FRP plate members from the form.

A FRP plate member constructed according to the present invention comprises a color face layer having a color design, a FRP layer formed of fiberglass reinforced plastics and bonded to one side of the color face layer, a resin layer bonded to one side of the FRP layer opposite to the color face layer, and a perforated backing sheet bonded to one side of the resin layer opposite to the FRP layer.

As indicated, the FRP plate member fabrication method of the present invention enables multiple FRP plate members to be fabricated at a time, therefore the FRP plate manufacturing cost is relatively reduced. Because a FRP plate member constructed according to the present invention is comprised of a color face layer, a FRP layer of fiberglass reinforced plastics, a resin layer bonded to one side of the FRP layer, and a perforated backing sheet, it is acid and alkali resisting as well as fire resisting. The backing sheet greatly reinforces the structural strength of the FRP plate member. The color face layer can be made having any of a variety of designs, making the FRP plate member more valuable.

### BRIEF DESCRIPTION OF THE DRAWINGS

The foregoing and other features and advantages of the present invention will be more clearly understood from the following detailed description and the accompanying drawings, in which,

FIG. 1 is a FRP plate member fabrication flow chart according to the prior art;

FIG. 2 is a FRP plate member fabrication flow chart according to a first embodiment of the present invention;

FIG. 3 is a detailed FRP plate member fabrication flow chart according to the first embodiment of the present invention;

FIG. 4 is an exploded view explaining the fabrication of a FRP plate member according to the first embodiment of the present invention;

FIG. 5 is an elevational view of a FRP plate member made according to the first embodiment of the present invention;

FIG. 5A is an enlarged view of a part of FIG. 5;

FIG. 6 is a detailed FRP plate member fabrication flow chart according to a second embodiment of the present invention;

FIG. 7 is an exploded view explaining the fabrication of a FRP plate member according to the second embodiment of the present invention; and

FIG. 8 is an elevational view of a FRP plate member made according to the second embodiment of the present invention.

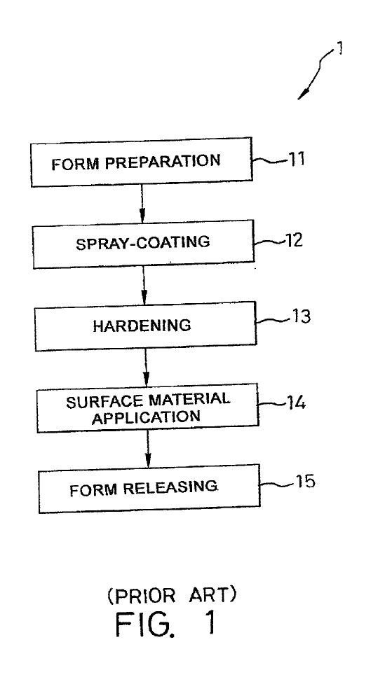

### DETAILED DESCRIPTION OF THE PREFERRED EMBODIMENTS

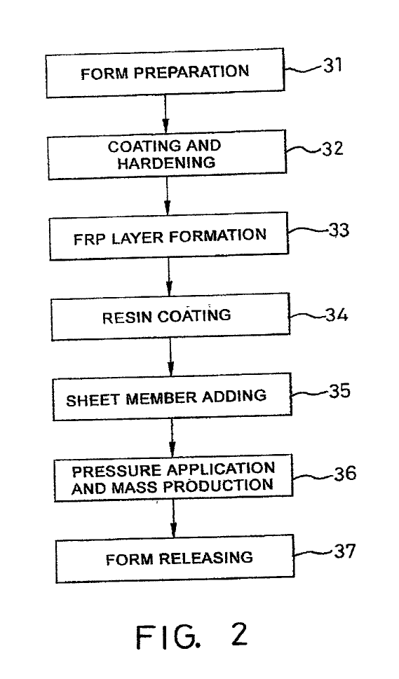

Referring to FIG. 2, a FRP (fiberglass reinforced plastics) plate member fabrication method in accordance with the present invention includes the steps of form preparation 31, coating and hardening 32, FRP layer formation 33, resin coating 34, sheet member adding 35, pressure application and mass production 36, and form releasing 37.

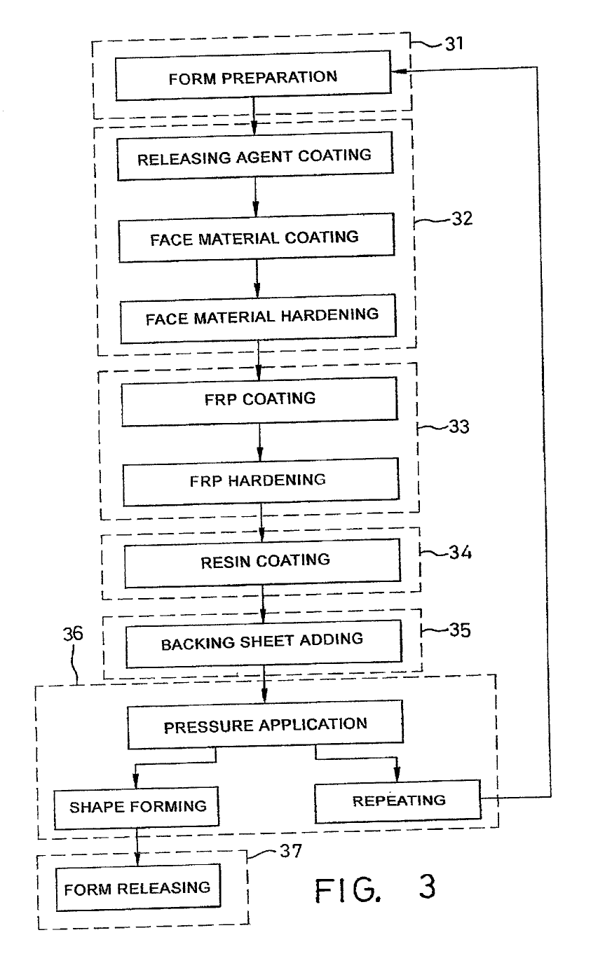

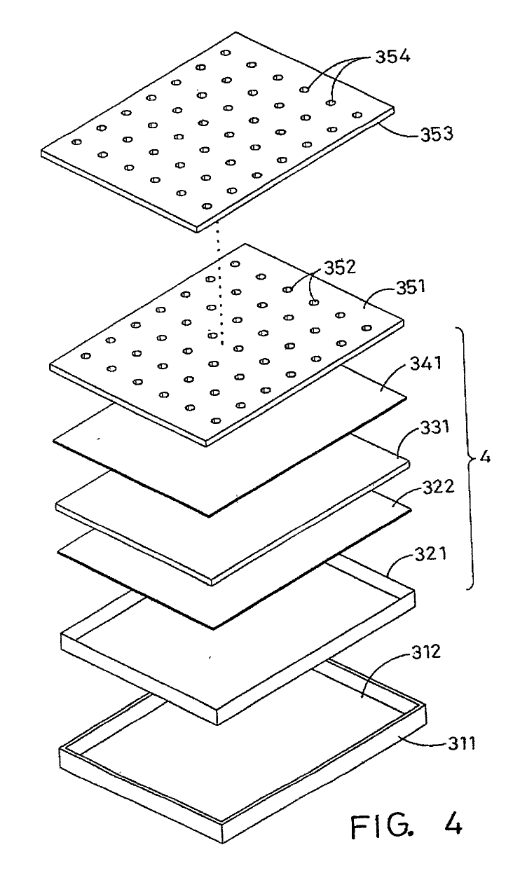

Referring to FIG. 3 and FIG. 4, the step of form preparation 31 is to prepare a form 311 having a cavity 312 made subject to predetermined dimensions and pattern. The step of coating and hardening 32 is to coat the surface of the cavity 312 with a layer of mold releasing agent 321 and a layer of face material 322 on the layer of mold releasing agent 321, and then to harden the layer of face material 322. The layer of face material 322 contains a hardening agent and coloring matter. The coloring matter used can be any of a variety of colors. The step of FRP layer formation 33 is to coat a layer of FRP (fiberglass reinforced plastics) 331 on the layer of face material 322 and then to harden the coating. The layer of FRP 331 is obtained from a fiberglass and resin mixture, having the material properties of acid and alkali resisting as well as fire resisting. The step of resin coating 34 is to coat a layer of resin 341 on the layer of FRP 331. The step of sheet member adding 35 is to add a backing sheet 351 to the layer of resin 341 before hardening of the layer of resin 341. The backing sheet 351 is a perforated sheet member 351 having evenly distributed pores 352. The step of pressure application and mass production 36 is to apply a downward pressure to the backing sheet 351 against the form 311 to force a part of the layer of resin 341 into the pores 352 and to force air out of the layer of resin 341. The steps from 31 through 35 may be repeatedly employed for making multiple FRP plate members at a time. At final, before the performance of the step of form releasing 37, a wooden sheet member 353 is placed on the last backing sheet 351, and then downward pressure is employed to the wooden sheet member 353 against the form 311. The wooden sheet member 353 is a perforated sheet member having evenly distributed pores 354. The wooden sheet member 353 enables air to be forced out of the layer of resin 341, and prevents the layer of resin 341 from flowing over the backing sheet 351 during its liquid state. After the step of pressure application and mass production 36, the step of form releasing 37 is employed to release the molded and hardened FRP plate member(s) 4 from the form 311.

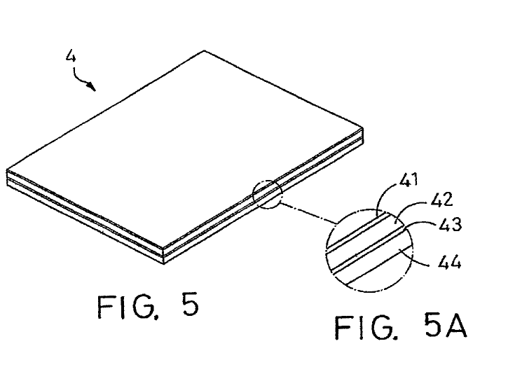

FIGS. 5 and 5A show the structure of a FRP plate member made according to the aforesaid fabrication method. As illustrated, the FRP plate member 4 comprises a color face layer 41, a FRP layer 42, a resin layer 43, and a backing sheet layer 44. The color face layer 41 has an embossed surface showing a design. The FRP layer 42 is a layer of acid, alkali, and fire resisting material sandwiched in between the color face layer 41 and the resin layer 43 to reinforce the structural strength of the FRP plate member. The backing sheet layer 44 is bonded to one side of the resin layer 43 opposite to the FRP layer 42 to reinforce the structural strength of the FRP plate member. The finished FRP plate member 4 can be cut into different sizes for different purposes (for use as wall plates, ceiling plates, door panels, etc.).

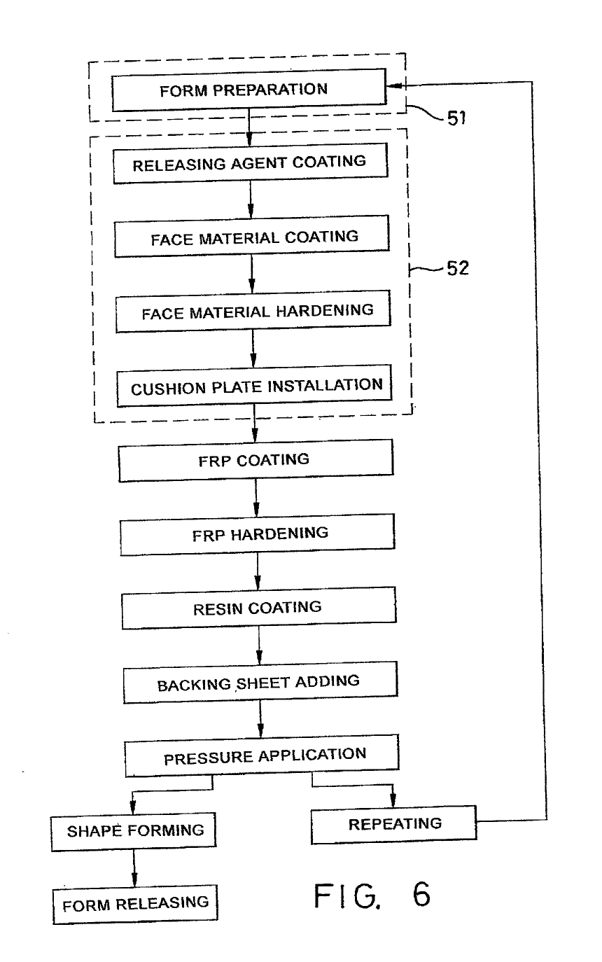

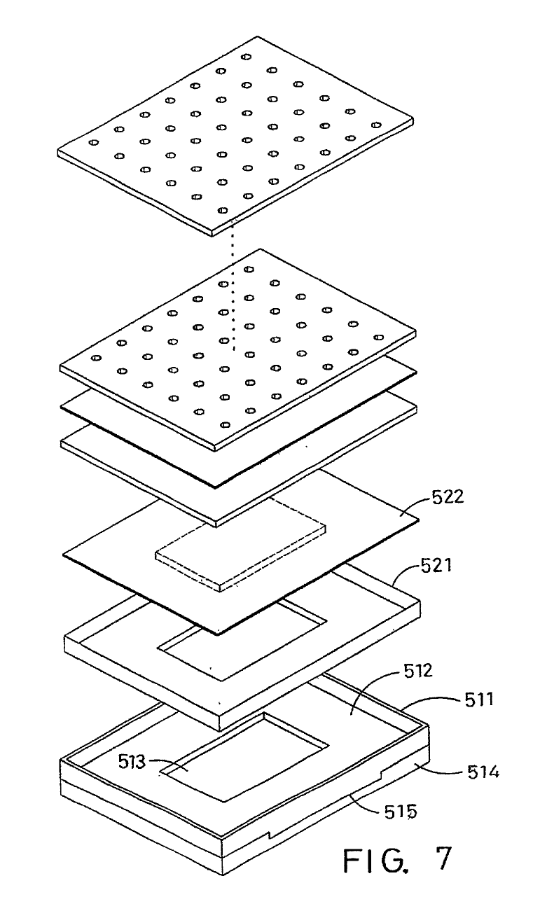

FIGS. 6 and 7 show an alternate form of the FRP plate member fabrication method. This alternate form is similar to the aforesaid FRP plate fabrication example with the exception of the step form preparation and the step coating and hardening. According to this alternate form, the step of form preparation 51 is to prepare a form 511 having a cavity 512 and a recessed (or protruded) portion 513 in the cavity 512; the step of coating and hardening 52 is to coat the surface of the cavity 312 with a layer of mold releasing agent 521 and a layer of face material 522 on the layer of mold releasing agent 521, and then to harden the layer of face material 522, and then to put a cushion plate 514 beneath the form 511, enabling the form 511 to be supported on the cushion plate 514. The cushion plate 514 has a planar bottom side and a top side bottom matching the bottom side of the form 511.

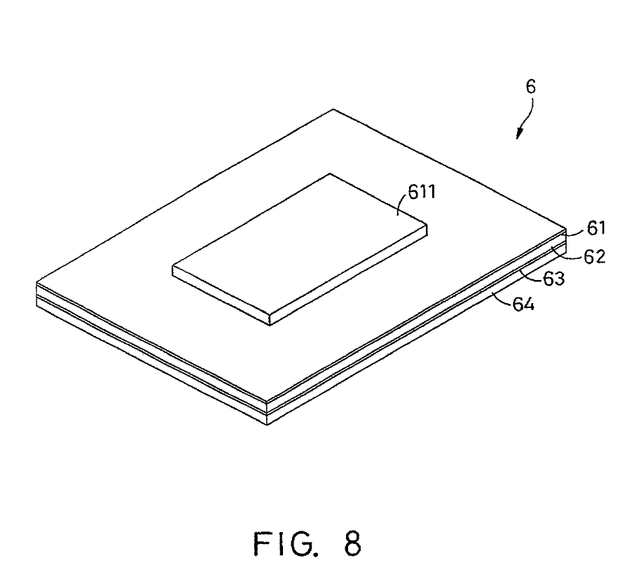

FIG. 8 show the structure of FRP plate member made according to the fabrication method of FIGS. 6 and 7. As illustrated, the FRP plate member 6 comprises a color face layer 61, a FRP layer 62, a resin layer 63, and a backing sheet layer 64. The color face layer 61 has a protruded (or recessed) ornamental portion 611.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A FRP plate member fabrication method comprising the steps of:
(a) form preparation to prepare a form having a cavity made subject to predetermined dimensions and pattern;
(b) coating and hardening to coat said cavity of said form with a layer of mold releasing agent and a layer of face material on said layer of mold releasing agent, and then to harden said layer of face material;
(c) FRP layer formation to coat a layer of FRP (fiberglass reinforced plastics) on said layer of face material and then to harden the coating;
(d) resin coating to coat a layer of resin on said layer of FRP;
(e) sheet member adding to add a backing sheet to said layer of resin before hardening of said layer of resin;
(f) pressure application and mass production to apply a downward pressure to said backing sheet against said form, and then to repeat the steps from (a) through (e) for making multiple FRP plate members at a time; and
(g) form releasing to release the molded and hardened FRP plate members from said form.

2. The FRP plate member fabrication method as claimed in claim 1, wherein said layer of face material is a mixture of a base material and a hardening agent.

3. The FRP plate member fabrication method as claimed in claim 1, wherein said backing sheet is a perforated sheet having a number of pores.

4. The FRP plate member fabrication method as claimed in claim 1 wherein said form is prepared having a protruded portion or recessed portion disposed in said cavity, and supported on a cushion plate in a flush manner.

5. A FRP plate member comprising:
a color face layer having a color design;
a FRP layer formed of fiberglass reinforced plastics and bonded to one side of said color face layer;
a resin layer bonded to one side of said FRP layer opposite to said color face layer; and
a backing sheet bonded to one side of said resin layer opposite to said FRP layer.

6. The FRP plate member as claimed in claim 5, wherein said backing sheet is a perforated sheet having a number or pores.
